(19) United States
(12) Patent Application Publication
(10) Pub. No.: US 2020/0263725 A1
(43) Pub. Date: Aug. 20, 2020

(54) SLEEVE SCREW

(71) Applicant: SUMEEKO INDUSTRIES CO., LTD., Kaohsiung (TW)

(72) Inventors: Kuang Yu Chen, Kaohsiung (TW); Shen Fu Wu, Kaohsiung (TW); Ming Yuan Chen, Kaohsiung (TW); Yueh Lin Tsai, Kaohsiung (TW)

(73) Assignee: Sumeeko Industries Co., LTD

(21) Appl. No.: 16/784,749

(22) Filed: Feb. 7, 2020

(30) Foreign Application Priority Data
Feb. 14, 2019 (TW) 108104931

(51) Int. Cl. F16B 37/14; F16B 5/02

(52) U.S. Cl. CPC F16B 37/145; F16B 13/124; F16B 5/0283

(57) ABSTRACT

Disclosed is a sleeve screw comprising a sleeve, a position limiting member and a screw, wherein the sleeve includes a hollow tube and a locking element which is formed by extending from an entrance opening into an inner space of the hollow tube, the position limiting member is disposed within the hollow tube and is abutted against by a bottom of an extending end of the locking element. Thereby, when the screw is inserted into the sleeve, the position limiting member abuts against the screw to retain the screw in the sleeve and the locking element abuts against the position limiting member to fix the position limiting member in the sleeve.

### FIELD OF THE INVENTION

The present invention relates to a screw, and more particularly relates to a sleeve screw.

### BACKGROUND OF THE INVENTION

A sleeve screw is with advantage of screw retaining. Therefore, in sake of quick assembly, the sleeve screw is commonly used for pre-assembling large objects, such as buildings, street lights and automotive engines.

The structure of a sleeve screw mainly includes a sleeve and a screw, wherein the screw is inserted into the sleeve from one end of the sleeve toward the other end of the sleeve, and a screw head is exposed outside the sleeve.

However, a conventional sleeve screw does not provide with a retaining structure between the screw and the sleeve. It causes the screw within the sleeve may easily come out from the sleeve. Accordingly, it is necessary to improve the conventional sleeve screw.

### SUMMARY OF THE INVENTION

Therefore, one objective of the present invention is to provide a sleeve screw, which can retain the screw within the sleeve and can be manufactured by a simplified process.

In order to overcome the technical problems in prior art, the present invention provides a sleeve screw, comprising: a sleeve including a hollow tube and a locking element, the hollow tube being provided with an entrance opening and an exit opening at two ends of the hollow tube respectively, the locking element being formed by extending, in a direction from the entrance opening to the exit opening, into an inner space of the hollow tube; a position limiting member disposed within the hollow tube and being abutted against a bottom of an extending end of the locking element, the position limiting member including a connection element and a plurality of position limiting elements, the position limiting member is disposed on an inner surface of the hollow tube and is abutted against by the bottom of the extending end of the locking element, the plurality of position limiting elements being in form as protruding from the connection element toward a center axis of the hollow tube and also protruding toward the exit opening in a manner each position limiting element is formed with an arc portion which is curved toward the exit opening, wherein ends of the plurality of position limiting elements form a screw passing space; and a screw disposed within the inner space of the hollow tube, a front section of a surface of the screw being formed with a threading portion, wherein the locking element abuts against the position limiting member to fix the position limiting member in the sleeve, when the threading portion on the front section of the surface of the screw passes, from the entrance opening toward the exit opening, through the screw passing space to insert into the sleeve, the plurality of position limiting elements are pushed by a thread of the threading portion to bent toward the exit opening, and after the front section of surface of the threading portion has passed through the plurality of position limiting elements, the plurality of position limiting elements return toward their original positions to abut against a non-threading portion of the screw, which is a section other than the front section of the surface of the screw.

In one embodiment of the present invention, a sleeve screw is provided, wherein the entrance opening extends toward the inner space of the hollow tube to form a stepped entrance portion, the stepped entrance portion is formed with a stepped surface recessed downwardly and inwardly from an inner surface of the stepped entrance portion.

In one embodiment of the present invention, a sleeve screw is provided, wherein the locking element is formed extending inwardly into the hollow tube from an upper internal surface of the stepped entrance portion through the stepped surface in a direction downward and toward the exit opening.

In one embodiment of the present invention, a sleeve screw is provided, wherein a plurality of the locking elements are provided, and a spacing distance is formed between each adjacent two locking elements.

In one embodiment of the present invention, a sleeve screw is provided, wherein the locking element is formed fitting the inner surface of the hollow tube while extending downwardly from the entrance opening toward the exit opening.

In one embodiment of the present invention, a sleeve screw is provided, wherein the connection element is a disk-like connection element, the plurality of position limiting elements protrude from an internal surface of the connection element toward the center axis of the hollow tube and protrude toward the exit opening.

In one embodiment of the present invention, a sleeve screw is provided, wherein a distance between the position limiting member and the entrance opening is less than a distance between the position limiting member and the exit opening.

In one embodiment of the present invention, a sleeve screw is provided, wherein the plurality of position limiting elements are positioned on the same horizontal plane.

In one embodiment of the present invention, a sleeve screw is provided, wherein the sleeve and the position limiting member are made of metal.

With the technical means adopted by the present invention, when the screw is inserted into the sleeve by inserting to the entrance opening of the sleeve to move through the screw passing space in a direction toward the exit opening of the sleeve, the plurality of position limiting elements of the sleeve will bend toward the exit opening of the sleeve because of the pushing force from the thread of the threading portion of the screw. After the threading portion passes through the plurality of position limiting elements, the plurality of position limiting elements return toward to their original positions such that the plurality of position limiting elements abut against the non-threading portion of the screw to retain the screw in the sleeve. Therefore, the screw in the sleeve is retained. The sleeve screw is thus able to achieve the goal of enabling to use plurality of sleeve screws to quickly fasten a large structure.

In addition, the structure of the present invention that the sleeve, the position limiting member and the screw are connected together could not only simplify the manufacturing process, but also enable the screw to be more difficult coming out from the sleeve. Furthermore, the locking element of the present invention is provided to abut against the position limiting member to fix the position limiting member in the sleeve, thereby avoiding displacement of the position limiting member while the screw passes through the screw passing space.

### BRIEF DESCRIPTION OF THE DRAWINGS

FIG. 1 is a schematic drawing illustrating a sleeve screw according to one embodiment of the present invention;

FIG. 2 is a schematic exploded view of the sleeve screw according to the embodiment of the present invention;

FIG. 3 is a schematic top view of the sleeve screw according to the embodiment of the present invention;

FIG. 4 is a schematic cross-section view of a position limiting element and a screw of the sleeve screw according to the embodiment of the present invention;

FIG. 5 is a schematic cross-section view of a position limiting member and a locking element of the sleeve screw according to the embodiment of the present invention; and

FIG. 6 is a schematic drawing illustrating the sleeve screw, before the locking element is bent in the hollow tube, according to the embodiment of the present invention.

### DETAILED DESCRIPTION OF THE PREFERRED EMBODIMENTS

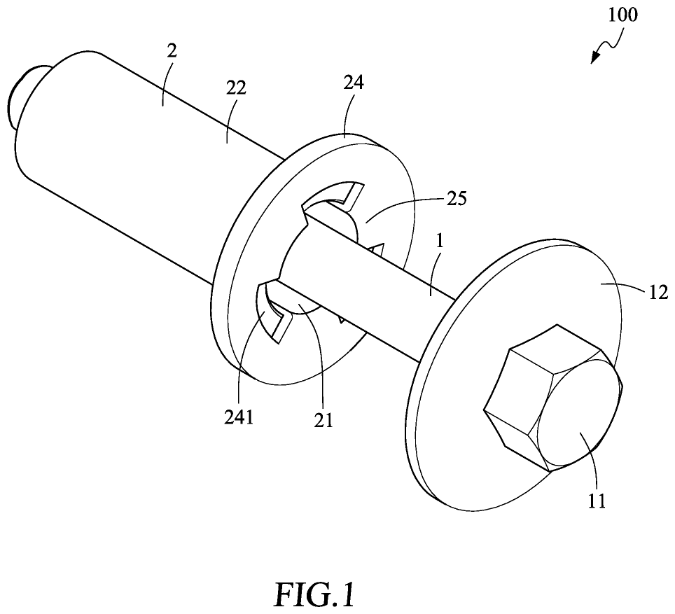

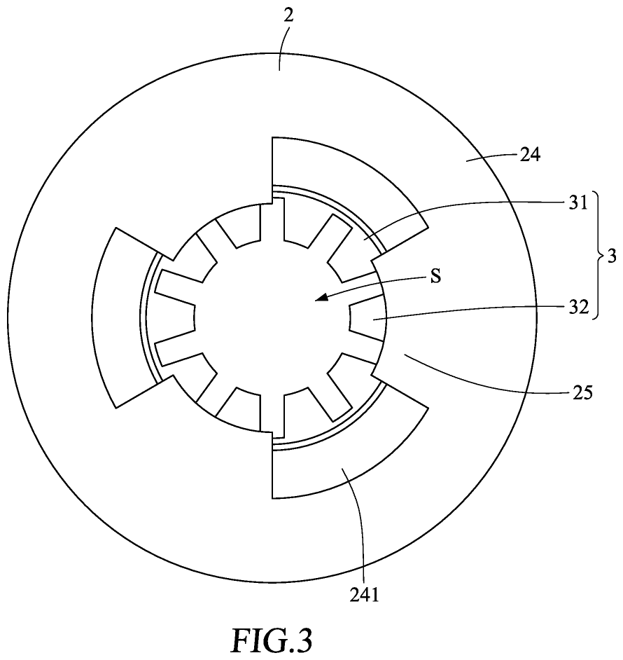

The preferred embodiments of the present invention are described in detail below with reference to FIG. 1 to FIG. 6. The description is used for explaining the embodiments of the present invention only, but not for limiting the scope of the claims.

As shown in FIG. 1 to FIG. 5, a sleeve screw 100 according to one embodiment of the present invention includes a screw 1, a sleeve 2 and a position limiting member 3.

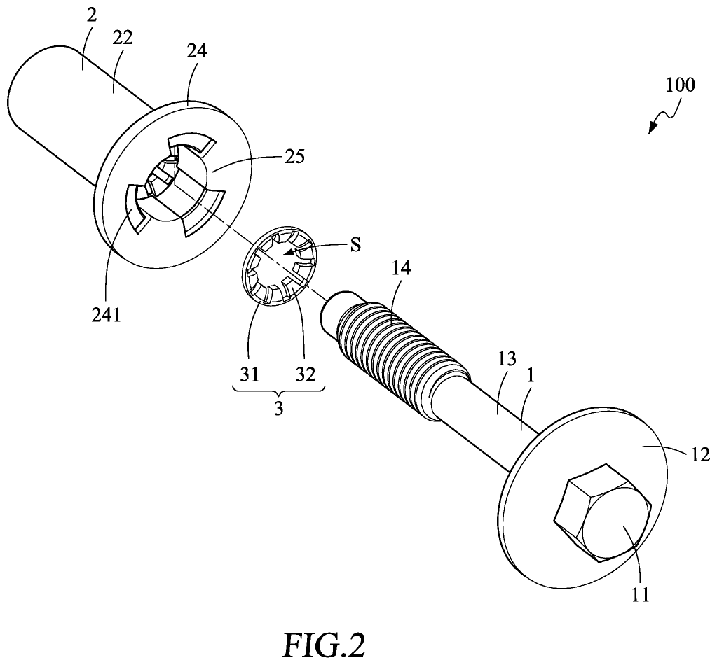

As shown in FIG. 2, in the embodiment, the screw 1 includes a screw head 11, a flange 12 and a screw body 13. The screw body 13 is formed with a threading portion 14 on an external surface of one end of the screw body 13. The screw head 11 and the flange 12 are provided at the other end of the screw body 13. The flange 12 is positioned between the screw head 11 and the threading portion 14. Specifically, the flange 12 is a disc-shaped body formed extending from the other end of the screw body 13 and is connected to the screw head 11. In the embodiment, the screw head 11 is a hexagonal screw head.

The sleeve 2 is made of material selected from metals. As shown in FIG. 1 to FIG. 5, the sleeve 2 includes a hollow tube 22, an entrance end 24 and a locking element 25, and is provided with an entrance opening 21 and an exit opening 23 at two ends of the hollow tube 22 respectively.

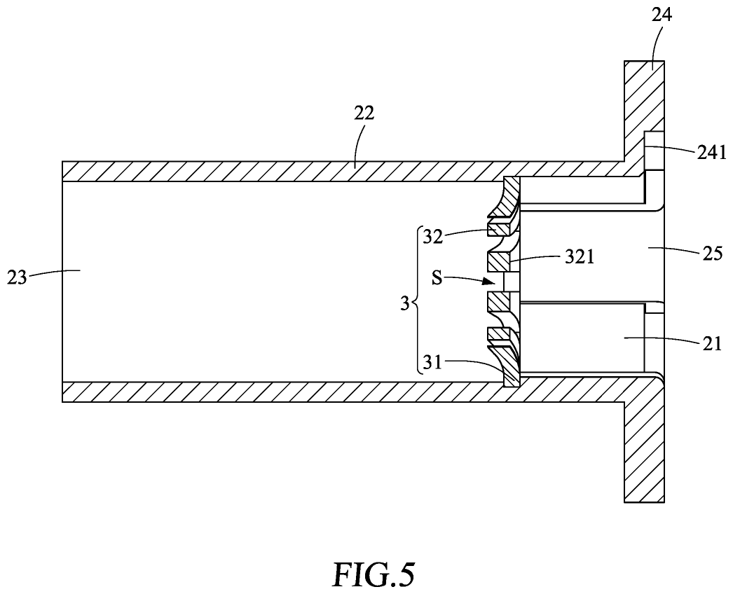

As shown in FIG. 1 and FIG. 5, one end of the sleeve 2 is formed as the entrance end 24 at which the entrance opening 21 is formed. In the embodiment, the entrance opening 21 extends toward an inner space of the hollow tube 22 to form a stepped entrance portion, and the stepped entrance portion is formed with a stepped surface 241 recessed downwardly and inwardly from an inner surface of the stepped entrance portion. The locking element 25 is formed extending inwardly into the hollow tube 22 from an upper internal surface of the stepped entrance portion through the stepped surface 241 in a direction downward and toward the exit opening 23. Preferably, the locking element 25 is formed fitting the inner surface of the hollow tube 22 while extending downwardly from the entrance opening 21 toward the exit opening 23. In the embodiment, three locking elements 25 are provided, and a spacing distance is formed between each adjacent two locking elements 25. However, the present invention is not limited to this. In other embodiments, the number of the locking elements may be increased or decreased as appropriate.

As shown in FIG. 1 to FIG. 5, the position limiting member 3 is made of material selected from metals. The position limiting member 3 is disposed within the hollow tube 22 and is abutted against a bottom of an extending end of the locking element 25. The position limiting member 3 includes a connection element 31 and a plurality of position limiting elements 32. The position limiting member 3 is disposed on an inner surface of the hollow tube 22 and is abutted against by the bottom of the extending end of the locking element 25. Specifically, the connection element 31 is a disc-shaped element. The plurality of position limiting elements 32 are in form as protruding from the connection element 31 toward a center axis of the hollow tube 22 and also protruding toward the exit opening 23 in a manner that each position limiting element 32 is formed with an arc portion 321 which is curved toward the exit opening 23, wherein ends of the plurality of position limiting elements 32 form a screw passing space S. Preferably, a distance between the position limiting member 3 and the entrance opening 21 is less than a distance between the position limiting member 3 and the exit opening 23, and the plurality of position limiting elements 32 are positioned on the same horizontal plane.

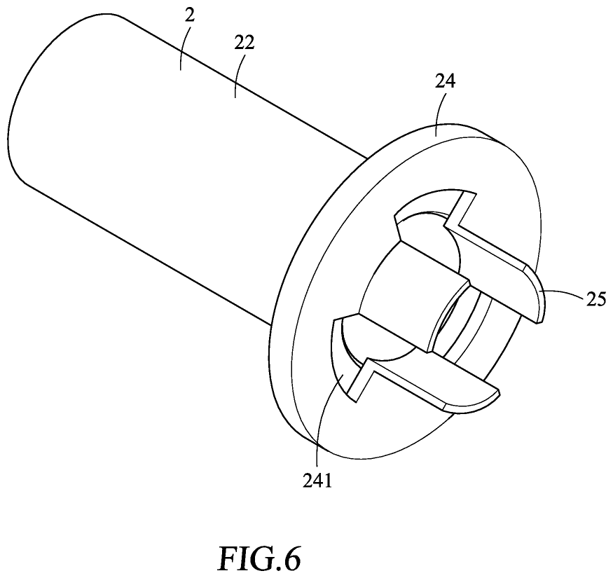

It is worth mentioning that, as shown in FIG. 6, the locking element 25 is formed by a pressing process. Before being pressed, the locking element 25 extends upwardly in a direction away from the hollow tube 22. After the position limiting member 3 is placed in the sleeve 2, the locking element 25 is bent to the inner space of the hollow tube 22 by the pressing process to fix the position limiting member 3 in the sleeve 2.

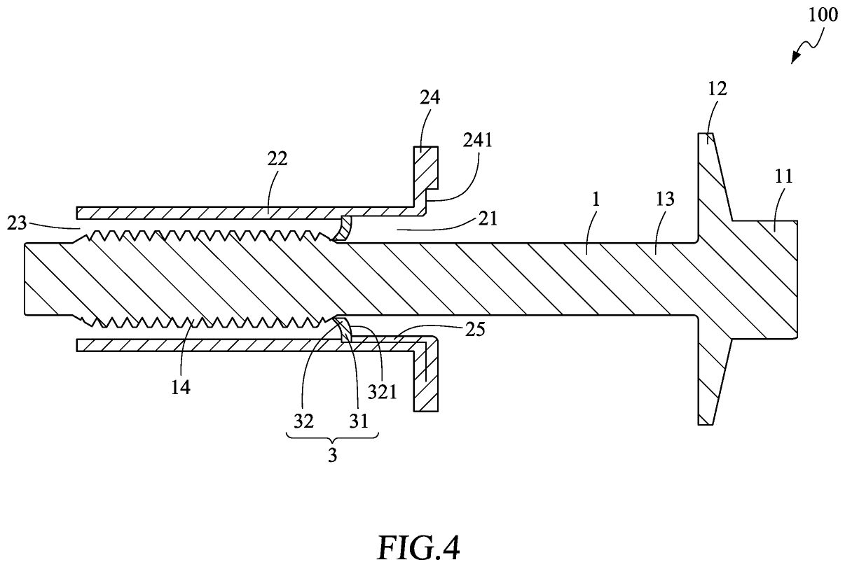

As shown in FIG. 4 and FIG. 5, when the threading portion 14 on the front section of the surface of the screw 1 passes, from the entrance opening 21 toward the exit opening 23, through the screw passing space S to insert into the sleeve 2, the plurality of position limiting elements 32 are pushed by a thread of the threading portion 14 to bent toward the exit opening 23. After the front section of surface of the threading portion 14 passes through the plurality of position limiting elements 32, the plurality of position limiting elements 32 return toward their original positions to abut against a non-threading portion of the screw 1, which is a section other than the front section of the surface of the screw 1. Thereby, the screw 1 is retained in the sleeve 2, and the locking element 25 abuts against the position limiting member 3 to fix the position limiting member 3 in the sleeve 2.

The above description is only an explanation of the preferred embodiments of the present invention. One having ordinary skill in the art can make various modifications according to the above description and the claims defined below. However, those modifications shall still fall within the scope of the present invention.

What is claimed is:

1. A sleeve screw, comprising:
a sleeve including a hollow tube and a locking element, the hollow tube being provided with an entrance opening and an exit opening at two ends of the hollow tube respectively, the locking element being formed by extending, in a direction from the entrance opening to the exit opening, into an inner space of the hollow tube;
a position limiting member disposed within the hollow tube and being abutted against a bottom of an extending end of the locking element, the position limiting member including a connection element and a plurality of position limiting elements, the position limiting member is disposed on an inner surface of the hollow tube and is abutted against by the bottom of the extending end of the locking element, the plurality of position limiting elements being in form as protruding from the connection element toward a center axis of the hollow tube and also protruding toward the exit opening in a manner each position limiting element is formed with an arc portion which is curved toward the exit opening, wherein ends of the plurality of position limiting elements form a screw passing space; and
a screw disposed within the inner space of the hollow tube, a front section of a surface of the screw being formed with a threading portion,
wherein the locking element abuts against the position limiting member to fix the position limiting member in the sleeve,
when the threading portion on the front section of the surface of the screw passes, from the entrance opening toward the exit opening, through the screw passing space to insert into the sleeve, the plurality of position limiting elements are pushed by a thread of the threading portion to bent toward the exit opening, and
after the front section of surface of the threading portion has passed through the plurality of position limiting elements, the plurality of position limiting elements return toward their original positions to abut against a non-threading portion of the screw, which is a section other than the front section of the surface of the screw.

2. The sleeve screw as claimed in claim 1, wherein the entrance opening extends toward the inner space of the hollow tube to form a stepped entrance portion, the stepped entrance portion is formed with a stepped surface recessed downwardly and inwardly from an inner surface of the stepped entrance portion.

3. The sleeve screw as claimed in claim 2, wherein the locking element is formed extending inwardly into the hollow tube from an upper internal surface of the stepped entrance portion through the stepped surface in a direction downward and toward the exit opening.

4. The sleeve screw as claimed in claim 1, wherein a plurality of the locking elements are provided, and a spacing distance is formed between each adjacent two locking elements.

5. The sleeve screw as claimed in claim 1, wherein the locking element is formed fitting the inner surface of the hollow tube while extending downwardly from the entrance opening toward the exit opening.

6. The sleeve screw as claimed in claim 1, wherein the connection element is a disk-like connection element, the plurality of position limiting elements protrude from an internal surface of the connection element toward the center axis of the hollow tube and protrude toward the exit opening.

7. The sleeve screw as claimed in claim 1, wherein a distance between the position limiting member and the entrance opening is less than a distance between the position limiting member and the exit opening.

8. The sleeve screw as claimed in claim 1, wherein the plurality of position limiting elements are positioned on the same horizontal plane.

9. The sleeve screw as claimed in claim 1, wherein the sleeve and the position limiting member are made of metal.
